(19) United States
(12) Patent Application Publication
(10) Pub. No.: US 2012/0327803 A1
(43) Pub. Date: Dec. 27, 2012

(54) APPARATUS AND METHOD FOR FORWARDING PACKET BY EVOLVED NODE-B IN WIRELESS COMMUNICATION SYSTEM

(76) Inventors: Neung-Hyung Lee, Seongnam-si (KR); Sung-Oh Kwon, Nowon-gu (KR)

(21) Appl. No.: 13/583,457

(22) PCT Filed: Mar. 8, 2011
(86) PCT No.: PCT/KR2011/001581

§ 371 Date: Sep. 7, 2012

(30) Foreign Application Priority Data
Mar. 8, 2010 (KR) 10-2010-0020381

(51) Int. Cl. H04W 24/00; H04W 36/00; H04W 72/04

(52) U.S. Cl. 370/252

(57) ABSTRACT

An apparatus and method for forwarding a packet when a handover is performed between evolved NodeBs (eNBs) in a wireless communication system are provided. In a method of scheduling a forwarding packet by a target eNB in the wireless communication system, the method includes receiving a User Equipment (UE)'s packet forwarded from a source eNB of the UE at the occurrence of a handover of the UE, determining a delay value of the packet by considering at least one of an X2 delay value and a queuing delay value with respect to the forwarded packet, and scheduling the packet on the basis of the determined delay value.

### TECHNICAL FIELD

Hi The present invention relates to an apparatus and method for forwarding a packet by an evolved NodeB (eNB) in a wireless communication system. More particularly, the present invention relates to an apparatus and method for forwarding a packet when a handover is performed between eNBs in the wireless communication system.

### BACKGROUND ART

Mobility control for a User Equipment (UE) in a 3rd Generation Partnership Project (3GPP) Long Term Evolution (LTE) system is achieved by a source Evolved-Universal Terrestrial Radio Access Network (E-UTRAN) NodeB (or a source eNB) on the basis of a measurement report of the UE. That is, the source eNB determines whether to perform a handover of the UE to a target E-UTRAN NodeB (or a target eNB) on the basis of the measurement report of the UE with respect to a neighboring eNB, and according to the determination, instructs the UE to perform the handover to the target eNB. Accordingly, the UE starts a process of the handover to the target eNB, and when the process of the handover to the target eNB is complete, the UE becomes a target of scheduling in the target eNB. Therefore, the UE may receive a service from the target eNB.

Meanwhile, packets which are not yet transmitted to the UE have to be forwarded by the source eNB to the target eNB while instructing the UE to perform the handover. Such a process is continuously performed until a path switching process is complete. The path switching process is a process of changing a downlink packet delivery path toward the UE from the source eNB to the target eNB. For this, a plurality of messages need to be exchanged among the target eNB, a Mobility Management Entity (MME), and a Serving GateWay (S-GW). That is, the downlink packet to be transmitted to the UE arrives to the source eNB before the path switching process is complete, and thus the source eNB has to forward this packet to the target eNB via an X2 interface.

Meanwhile, a 3GPP LTE system defines a threshold of delay required for packet transmission from a gateway to a UE for each Quality of Service (QoS) class of a service. The delay required for packet transmission from the gateway to the UE is classified into a core network delay between an eNB and the gateway connected in a wired network and a delay between the UE and the eNB. The core network delay is not much different for each QoS, and is defined to have a value of approximately 20 miliseconds (ms) on average. Therefore, a scheduler of the eNB performs scheduling by using a value obtained by subtracting the core network delay from a delay threshold defined for the QoS as delay information of a corresponding packet.

When the UE performs a handover in the 3GPP LTE system, a downlink packet of the UE is transmitted to the target eNB via the source eNB until the path switching process is complete, and this implies that an additional delay occurs in wired network transmission. A delay required for packet transmission from the source eNB to the target eNB will be hereinafter referred to as an X2 delay. In this case, the target eNB performs scheduling by using the value obtained by subtracting the core network delay from the delay threshold defined for the QoS of the downlink packet of the UE as the delay information of the corresponding packet. That is, when the target eNB performs scheduling on the UE's downlink packet forwarded from the source eNB according to the handover of the UE, a queuing delay (i.e., a delay time after the packet arrives to the source eNB and before the packet is forwarded to the target eNB) and an X2 delay occurring in the source eNB does not considered by the target eNB. As such, when the target eNB does not consider the queuing delay and the X2 delay in the source eNB, the packet forwarded from the source eNB to the target eNB according to the handover of the UE may be regarded by the target eNB as a packet that experiences a smaller delay than that actually experienced. Due to such incorrect delay information, scheduling of the packet is delayed. Accordingly, the UE receives the packet with a greater delay than a normal packet.

FIG. 1 illustrates an example of a packet forwarding method when a handover is performed between eNBs in a wireless communication system according to the prior art.

Referring to FIG. 1, a UE1 100-1 performs a handover to an eNB2 110-2 while receiving a voice service from an eNB 1 110-1. It is assumed that an X2 delay time from the eNB1 110-1 to the eNB2 110-2 is 20 ms. It is also assumed that each of downlink packets, which have already arrived to the eNB1 110-1 about 30 and 10 ms ago, is present in a buffer of the UE1 100-1 within the coverage of the eNB 1 110-1 at a handover start time. At the start of the handover process, the eNB 1 110-1 forwards the two packets existing in the buffer of the UE1 100-1 to the eNB2 110-2 via an X2 interface, and accordingly, the two packets forwarded to the eNB2 110-2 experience delays of 50 and 30 ms in total (i.e., a queuing delay of 30 and 10 ms+an X2 delay of 20 ms). However, since the eNB2 110-2 does not consider the queuing delay and X2 delay occurring in the eNB1 110-1, the eNB2 110-2 initializes the delay time of the forwarded two packets and packets that newly arrived to the eNB2 110-2 to 0 ms. Accordingly, although the UE1 100-1 has experienced a greater delay than that of packets of a UE2 100-2 that receives a service from the eNB2 110-2, a low priority may be assigned by the scheduler to the eNB2 110-.

### DISCLOSURE OF THE INVENTION

### Solution to Problem

An aspect of the present invention is to solve at least the above-mentioned problems and/or disadvantages and to provide at least the advantages described below. Accordingly, an aspect of the present invention is to provide an apparatus and method for forwarding a packet when a handover is performed between evolved NodeBs (eNBs) in a wireless communication system.

Another aspect of the present invention is to provide an apparatus and method for forwarding information on a queuing delay from a source eNB to a target eNB together with a downlink packet of a User Equipment (UE) when a handover of the UE is performed in a wireless communication system, in order to persistently guarantee Quality of Service (QoS) of a service received from the source eNB to the UE at the occurrence of the handover.

Another aspect of the present invention is to provide an apparatus and method for performing scheduling by a target eNB in consideration of at least one of an X2 delay and a queuing delay with respect to a downlink packet forwarded from a source eNB when a handover of a UE occurs in a wireless communication system, in order to persistently guarantee QoS of a service received from the source eNB to the UE at the occurrence of the handover.

In accordance with an aspect of the present invention, a method of scheduling a forwarding packet by a target eNB in a wireless communication system is provided. The method includes receiving a UE's packet forwarded from a source eNB of the UE at the occurrence of a handover of the UE, determining a delay value of the packet by considering at least one of an X2 delay value and a queuing delay value with respect to the forwarded packet, and scheduling the packet on the basis of the determined delay value.

In accordance with another aspect of the present invention, a method for forwarding a packet by a source eNB in a wireless communication system is provided. The method includes determining whether there is a packet which is not yet transmitted to a UE, with respect to the UE that performs a handover, confirming a queuing delay value of the packet if there is the packet which is not yet transmitted to the UE, and forwarding the confirmed queuing delay value to a target eNB of the UE together with the packet.

In accordance with another aspect of the present invention, a target eNB for scheduling a forwarding packet in a wireless communication system is provided. The target eNB includes a network manager for receiving a UE's packet forwarded from a source eNB of the UE at the occurrence of a handover of the UE, and a scheduler for determining a delay value of the packet by considering at least one of an X2 delay value and a queuing delay value with respect to the forwarded packet, and for scheduling the packet on the basis of the determined delay value.

In accordance with another aspect of the present invention, a source eNB for forwarding a packet in a wireless communication system is provided. The source eNB includes a scheduler for determining whether there is a packet which is not yet transmitted to a UE, with respect to the UE that performs a handover, and for confirming a queuing delay value of the packet if there is the packet which is not yet transmitted to the UE, and a network manager for forwarding the confirmed queuing delay value to a target eNB of the UE together with the packet.

### BRIEF DESCRIPTION OF DRAWINGS

The above and other aspects, features and advantages of certain exemplary embodiments of the present invention will be more apparent from the following detailed description taken in conjunction with the accompanying drawings, in which:

FIG. 1 illustrates an example of a packet forwarding method when a handover is performed between evolved NodeBs (eNBs) in a wireless communication system according to the prior art;

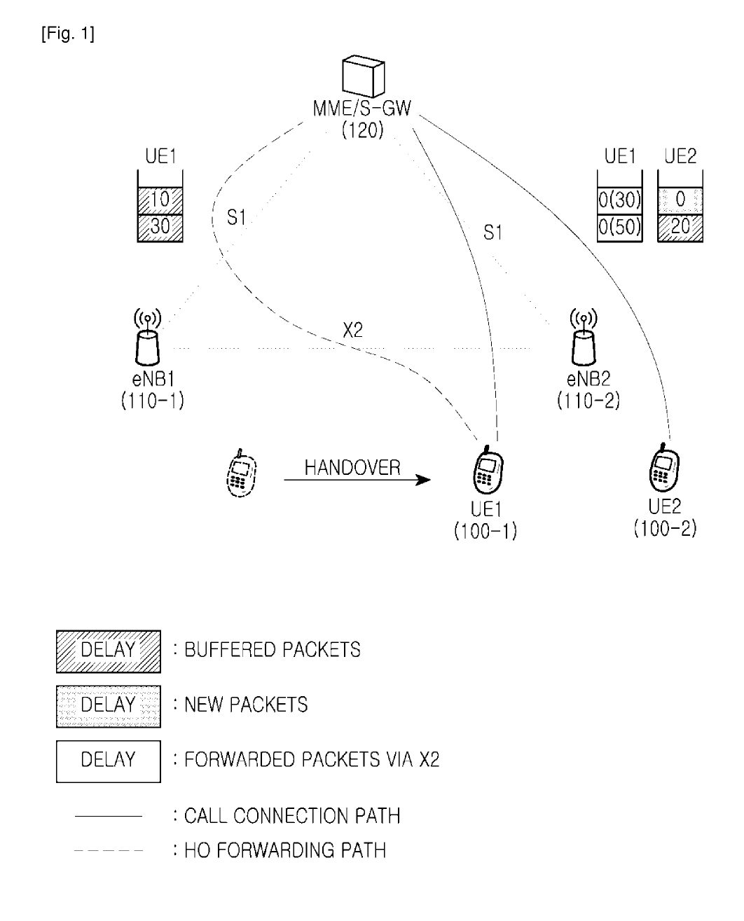

FIG. 2 is a flowchart illustrating a method for forwarding a downlink packet of a User Equipment (UE) from a source eNB to a target eNB at the occurrence of a handover of the UE in a wireless communication system according to a first embodiment of the present invention;

FIG. 3 is a flowchart illustrating a method in which a target eNB receives a UE's downlink packet forwarded from a source eNB when a handover of the UE occurs, and performs scheduling in a wireless communication system according to a first embodiment of the present invention;

FIG. 4 illustrates a method for forwarding a downlink packet of a UE by a source eNB to a target eNB at the occurrence of a handover of the UE and for scheduling the UE's downlink packet forwarded from the source eNB to the target eNB in a wireless communication system according to a first embodiment of the present invention;

FIG. 5 illustrates an example of a method for forwarding a downlink packet of a UE by a source eNB to a target eNB at the occurrence of a handover of the UE and for scheduling the UE's downlink packet forwarded from the source eNB to the target eNB in a wireless communication system according to a second embodiment of the present invention;

FIG. 6 illustrates an example of a method for forwarding a downlink packet of a UE by a source eNB to a target eNB at the occurrence of a handover of the UE and for scheduling the UE's downlink packet forwarded from the source eNB to the target eNB in a wireless communication system according to a third embodiment of the present invention; and

FIG. 7 is a block diagram illustrating a structure of an eNB in a wireless communication system according to an exemplary embodiment of the present invention.

### BEST MODE FOR CARRYING OUT THE INVENTION

The present invention will now be described more fully with reference to the accompanying drawings, in which exemplary embodiments of the invention are shown. In the description of the present invention, if it is determined that a detailed description of commonly-used technologies or structures related to the invention may unintentionally obscure the subject matter of the invention, the detailed description will be omitted. Also, since later-described terms are defined in consideration of the functions of the present invention, they may vary according to users' or operators' intentions or practice. Hence, the terms must be interpreted based on the contents of the entire specification.

The present invention described below relates to an apparatus and method for forwarding information on a queuing delay from a source evolved NodeB (eNB) to a target eNB together with a downlink packet of a User Equipment (UE) when a handover of the UE is performed in a wireless communication system, and for performing scheduling by the target eNB in consideration of at least one of an X2 delay and a queuing delay with respect to a downlink packet forwarded from the source eNB.

Although a 3rd Generation Partnership Project (3GPP) Long Term Evolution (LTE) system will be described in the present invention for example, the present invention is applicable to all systems in which packets are forwarded at the occurrence of a handover between eNBs.

Three types of methods are proposed in the present invention.

### First Embodiment

A method in which a target eNB initializes a packet delay value to a sum of an X2 delay value and a queuing delay value of a source eNB with respect to a forwarded downlink packet.

### Second Embodiment

A method in which a target eNB initializes a packet delay value to a queuing delay value of a source eNB with respect to a forwarded downlink packet.

### Third Embodiment

A method in which a target eNB initializes a packet delay value to an X2 delay value with respect to a forwarded downlink packet.

First, the method in which the target eNB initializes the packet delay value to the sum of the X2 delay value and the queuing delay value of the source eNB with respect to the forwarded downlink packet will be described according to the first embodiment.

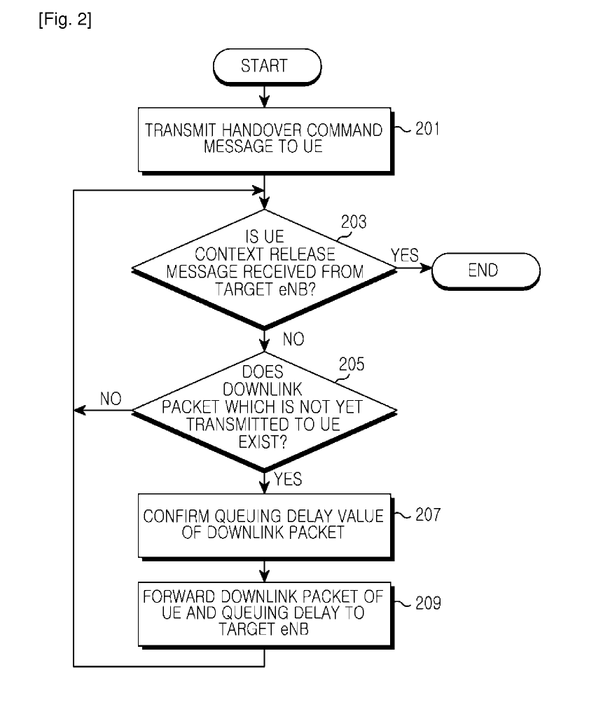

FIG. 2 is a flowchart illustrating a method for forwarding a downlink packet of a UE from a source eNB to a target eNB at the occurrence of a handover of the UE in a wireless communication system according to the first embodiment of the present invention.

Referring to FIG. 2, the source eNB transmits a handover command message to the UE in step 201. Herein, the source eNB determines whether to perform a handover to the UE on the basis of a measurement report message received from the UE, and if it is determined to perform the handover, transmits a handover request message to the target eNB. In this case, upon receiving a handover response ACKnowledge (ACK) message from the target eNB to accept the handover, the source eNB may transmit the handover command message to the UE to instruct the handover to the target eNB. It is assumed in the embodiment of the present invention that the handover command message is transmitted to the UE upon receiving the handover response ACK message from the target eNB.

In step 203, the source eNB determines whether a UE context release message is received from the target eNB within a pre-determined time. Herein, upon completion of a path switching process for changing a downlink packet delivery path toward the UE from the source eNB to the target eNB through exchange of a plurality of messages with a Mobility Management Entity (MME)/Serving GateWay (S-GW), the target eNB may request release of resources related to the UE by transmitting the UE context release message to the source eNB.

If it is determined in step 203 that the UE context release message is received from the target eNB within the predetermined time, the source eNB releases the resources related to the UE, and the procedure of FIG. 2 ends.

Otherwise, if it is determined in step 203 that the UE context release message is not received from the target eNB within the predetermined time, proceeding to step 205, the source eNB determines whether a downlink packet which is not yet transmitted to the UE exists in a buffer.

If it is determined in step 205 that the downlink packet which is not yet transmitted to the UE does not exist in the buffer, returning to step 203, the subsequent steps are repeated.

Otherwise, if it is determined in step 205 that the downlink packet which is not yet transmitted to the UE exists in the buffer, proceeding to step 207, the source eNB confirms a queuing delay value of the downlink packet.

In step 209, the source eNB extracts the downlink packet of the UE from the buffer, and forwards the extracted downlink packet and the confirmed queuing delay value for the packet to the target eNB. Then, returning to step 203, the subsequent steps are repeated.

Herein, the queuing delay value of the packet may be forwarded in the following manner. When the downlink packet of the UE arrives from the MME/S-GW, the source eNB generates a time stamp at an arrival time and stores it in the buffer together with the packet. When the packet is forwarded to the target eNB, the source eNB forwards the time stamp generated at the arrival time and a time stamp of a forwarding time to the target eNB together with the packet. Accordingly, the target eNB may measure the queuing delay value of the packet by determining a difference between the time stamp of the arrival time and the time stamp of the forwarding time.

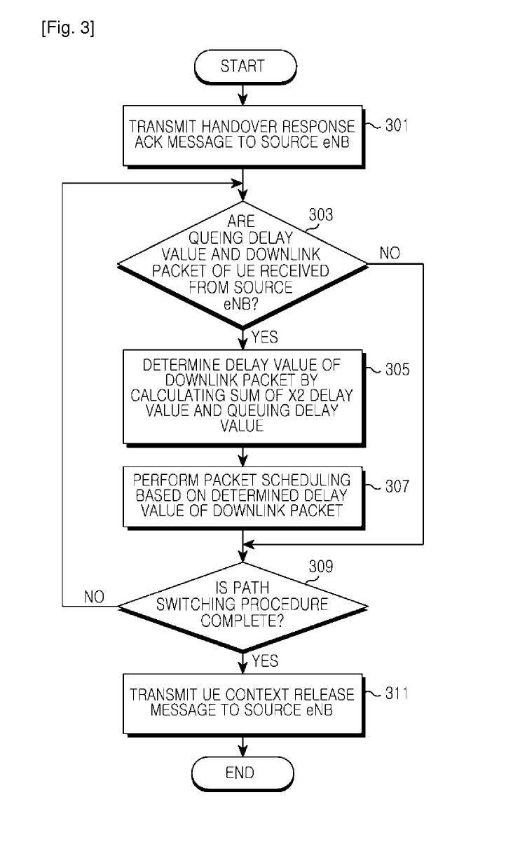

FIG. 3 is a flowchart illustrating a method in which a target eNB receives a UE's downlink packet forwarded from a source eNB when a handover of the UE occurs, and performs scheduling in a wireless communication system according to the first embodiment of the present invention.

Referring to FIG. 3, the target eNB transmits a handover response ACK message to the source eNB in step 301. Herein, the target eNB determines whether to accept the handover of the UE upon receiving a handover request message from the source eNB, and may transmit the handover response ACK message or a handover response negative ACK (NACK) message including a determination result to the source eNB. It is assumed in the embodiment of the present invention that the target eNB transmits the handover response ACK message to the source eNB to accept the handover.

In step 303, the target eNB determines whether a queuing delay value and a downlink packet of the UE are received from the source eNB during a pre-determined time.

If it is determined in step 303 that the queuing delay value and the downlink packet of the UE are not received from the source eNB, the procedure proceeds to step 309.

Otherwise, if it is determined in step 303 that the queuing delay value and the downlink packet of the UE are received from the source eNB, proceeding to step 305, the target eNB determines a delay value of the downlink packet by determining a sum of a predetermined X2 delay value and the received queuing delay value.

Herein, the X2 delay value may be determined by using two methods as follows. In the first method, a roundtrip time is measured by transmitting and receiving a ping message through an X2 interface between eNBs, and a value obtained by subtracting a specific-sized message processing time from the measured value is divided by 2. In the second method, a message for measuring an X2 delay between eNBs is additionally defined and used to additionally measure a bidirectional X2 delay. That is, this is a method in which a transmitting eNB transmits a message additionally defined for measurement of the X2 delay by inserting a time stamp of a transmission time to the message, and upon receiving the message, a receiving eNB transmits the message to the transmitting eNB by inserting the time stamp of the transmission time to the message.

In step 307, the target eNB performs scheduling on the downlink packet on the basis of the determined delay value of the downlink packet.

In the 309, the target eNB determines whether a path switching process is complete. Herein, the target eNB performs a path switching process for changing the downlink packet delivery path toward the UE from the source eNB to the target eNB by exchanging a plurality of messages with the MME/S-GW according to the handover of the UE.

If it is determined in step 309 that the path switching process is complete, proceeding to step 311, the target eNB transmits a UE context release message to the source eNB to request release of resources related to the UE.

Otherwise, if it is determined in step 309 that the path switching process is not complete, returning to step 303, the subsequent steps are repeated.

Thereafter, the procedure of FIG. 3 ends.

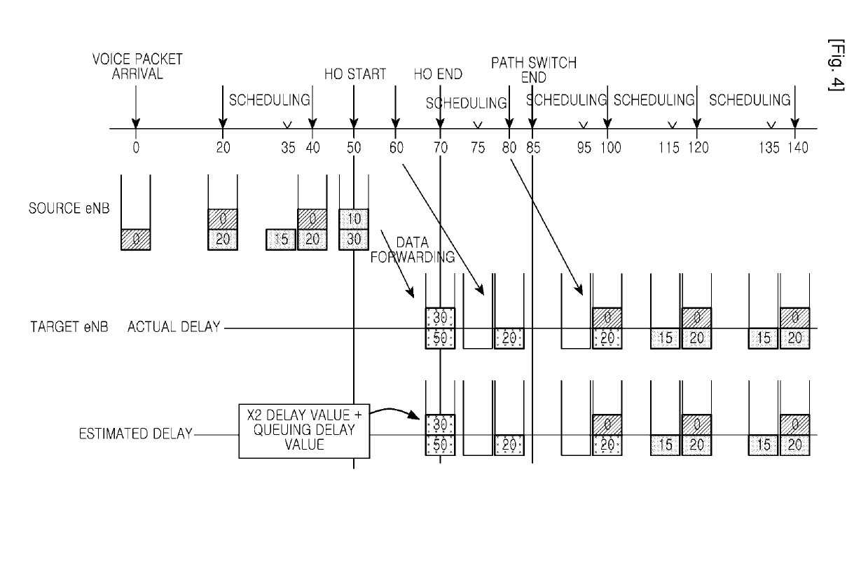

FIG. 4 illustrates a method for forwarding a downlink packet of a UE by a source eNB to a target eNB at the occurrence of a handover of the UE and for scheduling the UE's downlink packet forwarded from the source eNB to the target eNB in a wireless communication system according to the first embodiment of the present invention.

Referring to FIG. 4, the UE performs a handover to the target eNB while receiving a voice service from the source eNB. It is assumed that an X2 delay time from the source eNB to the target eNB is 20 ms. It is also assumed that a time required from the start and end of the handover process is 20 ms, a time required from the start of the handover to the end of a path switching process is 35 ms, and the UE's voice packet transmitted from an MME/S-GW arrives to the source eNB with a period of 20 ms, i.e., at a time of 0 ms, 20 ms, etc. This assumption is used until the path switching process is complete, and after the path switching process is complete, the voice packet arrives to the target eNB with a period of 20 ms. It is also assumed that the source eNB or the target eNB schedules a packet having a delay time exceeding 30 ms without exception, so that an average packet delay does not exceed 30 ms.

Under the aforementioned assumptions, the packet forwarding and scheduling process of FIG. 4 may be summarized in chronological order as follows.
At 0 ms: A 1^{st} new packet of the UE arrives to the source eNB.
At 20 ms: A 2^{nd} new packet of the UE arrives to the source eNB.
At 35 ms: The 1^{st} packet is scheduled.
At 40 ms: A 3^{rd} new packet of the UE arrives to the source eNB.
At 50 ms: A handover of the UE starts. The source eNB forwards a queuing delay value (30 and 10 ms) of each packet together with the 2^{nd} and 3^{rd} packets of the UE to the target eNB.
At 60 ms: A 4^{th} new packet of the UE arrives to the source eNB. The source eNB forwards a queuing delay value (i.e., 0 ms) of the 4^{th} packet to the target eNB together with the 4^{th} packet of the UE.
At 70 ms: The handover of the UE ends. The UE succeeds in a handover access. A queuing delay value (30 and 10 ms) of each packet arrives to the target eNB together with the 2^{nd} and 3^{rd} packets of the UE. The target eNB determines delay values (i.e., 50 and 30 ms) of the 2^{nd} and 3^{rd} packets by considering a queuing delay value and an X2 delay value of each packet.
At 75 ms: The 2^{nd} and 3^{rd} packets are scheduled.
At 80 ms: A queuing delay value (i.e., 0 ms) of the 4^{th} packet of the UE arrives to the target eNB together with the 4^{th} packet of the UE. The target eNB determines a delay value (i.e., 20 ms) of the 4^{th} packet by considering the queuing delay value and the X2 delay value of the 4^{th} packet. The 5^{th} new packet of the UE arrives to the source eNB. The source eNB forwards a queuing delay value (i.e., 0 ms) of the 5^{th} packet to the target eNB together with the 5^{th} packet of the UE.
At 85 ms: The path switching process is complete.
At 95 ms: The 4^{th} packet is scheduled.
At 100 ms: A queuing delay value (i.e., 0 ms) of the 5^{th} packet arrives to the target eNB together with the 5^{th} packet of the UE. The target eNB determines a delay value (i.e., 20 ms) of the 5^{th} packet by considering a queuing delay value and an X2 delay value of the 5^{th} packet. A new 6^{th} packet of the UE arrives to the target eNB.
At 115 ms: The 5^{th} packet is scheduled.
At 120 ms: A new 7^{th} packet of the UE arrives to the target eNB.
At 135 ms: The 6^{th} packet is scheduled.
At 140 ms: A new 8^{th} packet of the UE arrives to the target eNB.

When a delay value of a corresponding packet is initialized to a sum of a queuing delay value and an X2 delay value with respect to packets forwarded from the source eNB by the target eNB, a time required until each packet is scheduled may be summarized as follows.
1^{st} packet: arrived at 0 ms, scheduled at 35 ms=>delayed by 35 ms
2^{nd} packet: arrived at 20 ms, scheduled at 75 ms=>delayed by 55 ms
3^{rd} packet: arrived at 40 ms, scheduled at 75 ms=>delayed by 35 ms
4^{th} packet: arrived at 60 ms, scheduled at 95 ms=>delayed by 35 ms
5^{th} packet: arrived at 80 ms, scheduled at 115 ms=>delayed by 35 ms
6^{th} packet: arrived at 100 ms, scheduled at 135 ms=>delayed by 35 ms
=>Average delay: 38.33 ms

Herein, since there is no opportunity of scheduling during a time of performing the handover (i.e., during 20 ms), only the 2^{nd} packet arrived at 20 ms is additionally delayed by 20 ms, and the remaining packets experience only an original scheduling delay of 35 ms. As such, the packets forwarded from the source eNB to the target eNB are compensated for by an actually experienced delay (i.e., a queuing delay+an X2 delay), and considering that an average delay is 60.83 ms when the scheduling is performed according to the conventional technique in the same environment, a delay time may be decreased approximately by 25 ms.

Next, a method of initializing a queuing delay value of the source eNB to a delay value of the packet with respect to a downlink packet forwarded by the target eNB according to the second embodiment will be described. In this case, the operation of the source eNB is basically the same as that of the source eNB described in the first embodiment of FIG. 2, and the operation of the target eNB is basically the same as that of the target eNB described in the first embodiment of FIG. 3, except that, in step 305 of FIG. 3, the target eNB determines a delay value of a downlink packet by using only a queuing delay value received from the source eNB.

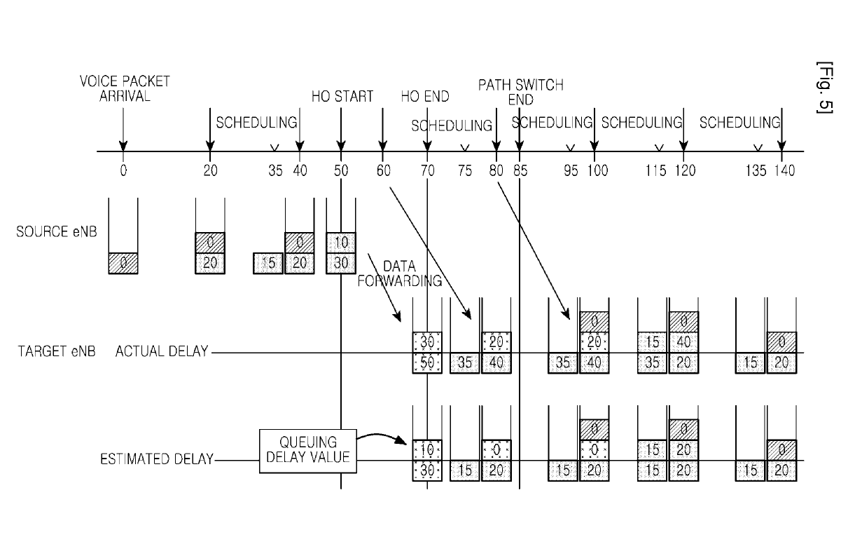

FIG. 5 illustrates an example of a method for forwarding a downlink packet of a UE by a source eNB to a target eNB at the occurrence of a handover of the UE and for scheduling the UE's downlink packet forwarded from the source eNB to the target eNB in a wireless communication system according to the second embodiment of the present invention.

Since the same assumption that used in FIG. 4 also applies to FIG. 5, descriptions thereof will be omitted.

Under the aforementioned assumptions, the packet forwarding and scheduling process of FIG. 5 may be summarized in chronological order as follows.
At 0 ms: A 1^{st} new packet of the UE arrives to the source eNB.
At 20 ms: A 2^{nd} new packet of the UE arrives to the source eNB.
At 35 ms: The 1^{st} packet is scheduled.
At 40 ms: A 3^{rd} new packet of the UE arrives to the source eNB.
At 50 ms: A handover of the UE starts. The source eNB forwards a queuing delay value (30 and 10 ms) of each packet together with the 2^{nd} and 3^{rd} packets of the UE to the target eNB.
At 60 ms: A 4^{th} new packet of the UE arrives to the source eNB. The source eNB forwards a queuing delay value (i.e., 0 ms) of the 4^{th} packet to the target eNB together with the 4^{th} packet of the UE.
At 70 ms: The handover of the UE ends. The UE succeeds in a handover access. A queuing delay value (30 and 10 ms) of each packet arrives to the target eNB together with the 2^{nd} and 3^{rd} packets. The target eNB determines delay values (i.e., 30 and 10 ms) of the 2^{nd} and 3^{rd} packets by considering a queuing delay value of each packet.
At 75 ms: The 2^{nd} packet is scheduled.
At 80 ms: A queuing delay value (i.e., 0 ms) of the 4^{th} packet of the UE arrives to the target eNB together with the 4^{th} packet of the UE. The target eNB determines a delay value (i.e., 0 ms) of the 4^{th} packet by considering the queuing delay value of the 4^{th} packet. The 5^{th} new packet of the UE arrives to the source eNB. The source eNB forwards the a queuing delay value (i.e., 0 ms) of the 5^{th} packet to the target eNB together with the 5^{th} packet of the UE.
At 85 ms: The path switching process is complete.
At 95 ms: The 3^{rd} packet is scheduled.
At 100 ms: A queuing delay value (i.e., 0 ms) of the 5^{th} packet arrives to the target eNB together with the 5^{th} packet of the UE. The target eNB determines a delay value (i.e., 0 ms) of the 5^{th} packet by considering a queuing delay value of the 5^{th} packet. A new 6^{th} packet of the UE arrives to the target eNB.
At 115 ms: The 4^{th} packet is scheduled.
At 120 ms: A new 7^{th} packet of the UE arrives to the target eNB.
At 135 ms: The 5^{th} and 6^{th} packets are scheduled.
At 140 ms: A new 8^{th} packet of the UE arrives to the target eNB.

When a delay value of a corresponding packet is initialized to a queuing delay value with respect to packets forwarded from the source eNB by the target eNB, a time required until each packet is scheduled may be summarized as follows.
1^{st} packet: arrived at 0 ms, scheduled at 35 ms=>delayed by 35 ms
2^{nd} packet: arrived at 20 ms, scheduled at 75 ms=>delayed by 55 ms
3^{rd} packet: arrived at 40 ms, scheduled at 95 ms=>delayed by 55 ms
4^{th} packet: arrived at 60 ms, scheduled at 115 ms=>delayed by 55 ms
5^{th} packet: arrived at 80 ms, scheduled at 135 ms=>delayed by 55 ms
6^{th} packet: arrived at 100 ms, scheduled at 135 ms=>delayed by 35 ms
=>Average delay: 51.67 ms

As such, the packets forwarded from the source eNB to the target eNB are compensated for by a queuing delay, and considering that an average delay is 60.83 ms when the scheduling is performed according to the conventional technique in the same environment, a delay time may be decreased approximately by 10 ms.

Next, a method of initializing an X2 delay value to a delay value of the packet with respect to a downlink packet forwarded by the target eNB according to the third embodiment will be described. In this case, the operation of the source eNB and the target eNB is basically the same as in the conventional technique, except that the source eNB forwards only a downlink packet of the UE to the target eNB without delay information, and the target eNB receives only the UE's downlink packet forwarded from the source eNB. In addition, the target eNB determines a delay value of the downlink packet by using the X2 delay value, and performs packet scheduling on the basis of the determined delay value of the downlink packet.

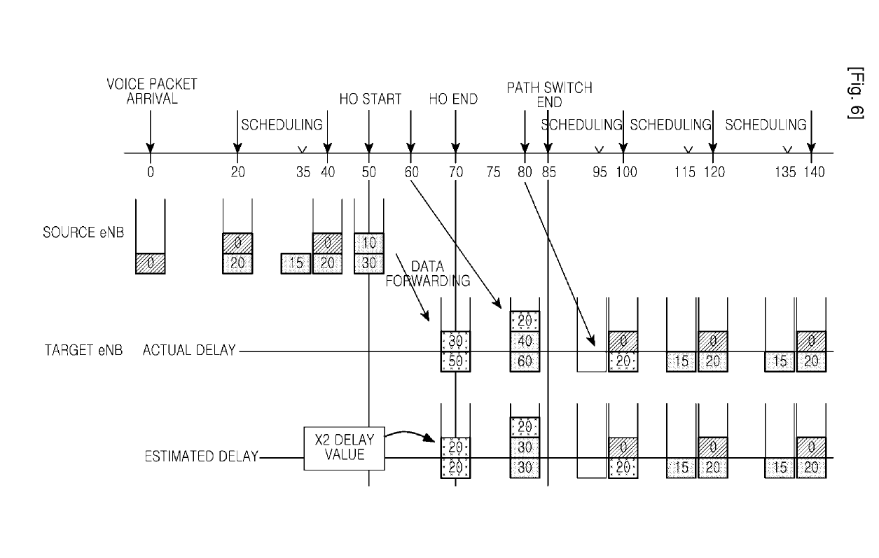

FIG. 6 illustrates an example of a method for forwarding a downlink packet of a UE by a source eNB to a target eNB at the occurrence of a handover of the UE and for scheduling the UE's downlink packet forwarded from the source eNB to the target eNB in a wireless communication system according to the third embodiment of the present invention.

Since the same assumption that used in FIG. 4 also applies to FIG. 6, descriptions thereof will be omitted.

Under the aforementioned assumptions, the packet forwarding and scheduling process of FIG. 6 may be summarized in chronological order as follows.
At 0 ms: A 1^{st} new packet of the UE arrives to the source eNB.
At 20 ms: A 2^{nd} new packet of the UE arrives to the source eNB.
At 35 ms: The 1^{st} packet is scheduled.
At 40 ms: A 3^{rd} new packet of the UE arrives to the source eNB.
At 50 ms: A handover of the UE starts. The source eNB forwards the 2^{nd} and 3^{rd} packets of the UE to the target eNB.
At 60 ms: A 4^{th} new packet of the UE arrives to the source eNB. The source eNB forwards the 4^{th} packet to the target eNB.
At 70 ms: The handover of the UE ends. The UE succeeds in a handover access. The 2^{nd} and 3^{rd} packets arrive to the target eNB. The target eNB determines delay values (i.e., 20 and 20 ms) of the 2^{nd} and 3^{rd} packets by considering an X2 delay value.
At 80 ms: The 4^{th} packet of the UE arrives to the target eNB. The target eNB determines a delay value (i.e., 20 ms) of the 4^{th} packet by considering the X2 delay value. The 5^{th} new packet of the UE arrives to the source eNB. The source eNB forwards the 5^{th} packet of the UE to the target eNB.
At 85 ms: The path switching process is complete.
At 95 ms: The 2^{nd}, 3^{rd}, and 4^{th} packets are scheduled.
At 100 ms: The 5^{th} packet of the UE arrives to the target eNB. The target eNB determines a delay value (i.e., 20 ms) of the 5^{th} packet by considering the X2 delay value. A new 6^{th} packet of the UE arrives to the target eNB.
At 115 ms: The 5^{th} packet is scheduled.
At 120 ms: A new 7^{th} packet of the UE arrives to the target eNB.
At 135 ms: The 6^{th} packet is scheduled.
At 140 ms: A new 8^{th} packet of the UE arrives to the target eNB.

When a delay value of a corresponding packet is initialized to a X2 delay value with respect to packets forwarded from the source eNB by the target eNB, a time required until each packet is scheduled may be summarized as follows.
1^{st} packet: arrived at 0 ms, scheduled at 35 ms=>delayed by 35 ms
2^{nd} packet: arrived at 20 ms, scheduled at 95 ms=>delayed by 75 ms
3^{rd} packet: arrived at 40 ms, scheduled at 95 ms=>delayed by 55 ms
4^{th} packet: arrived at 60 ms, scheduled at 95 ms=>delayed by 35 ms
5^{th} packet: arrived at 80 ms, scheduled at 115 ms=>delayed by 35 ms
6^{th} packet: arrived at 100 ms, scheduled at 135 ms=>delayed by 35 ms
=>Average delay: 45 ms

As such, the packets forwarded from the source eNB to the target eNB are compensated for by an X2 delay, and considering that an average delay is 60.83 ms when the scheduling is performed according to the conventional technique in the same environment, a delay time may be decreased approximately by 15 ms.

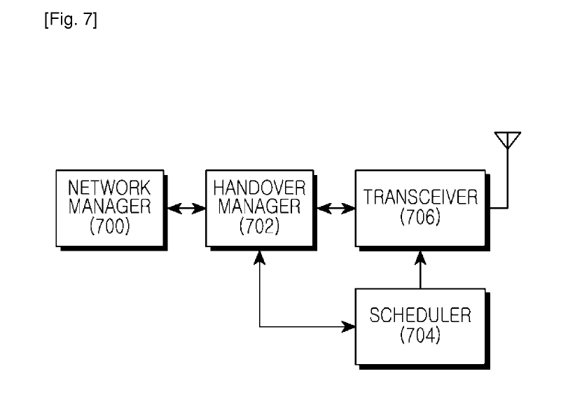

FIG. 7 is a block diagram illustrating a structure of an eNB in a wireless communication system according to an exemplary embodiment of the present invention. Since the structure of the eNB is equally applicable to both a source eNB and a target eNB, the same structure will be used in the following description.

Referring to FIG. 7, the eNB includes a network manager 700, a handover manager 702, a scheduler 704, and a transceiver 706.

The structure of the target eNB will be first described with reference to FIG. 7.

The network manager 700 communicates with a different eNB through an X2 interface. That is, the network manager 700 interprets a message received from the different eNB, and performs a function of generating and transmitting a transmission message. In addition to its typical function, according to the present invention, the network manager 700 receives a UE's packet forwarded from a source eNB of the UE at the occurrence of a handover of the UE, and provides the forwarded packet of the UE to the scheduler 704 via the handover manager 702. Herein, a queuing delay value of the UE may be forwarded to the network manager 700 from the source eNB together with the packet of the UE according to the embodiment of the present invention. In this case, a queuing delay value may be provided to the scheduler 704 via the handover manager 702 together with the forwarded packet of the UE.

The handover manager 702 processes and manages the handover of the UE, generates a handover related message to provide the message to the transceiver 706, and processes the handover related message received from the transceiver 706.

The scheduler 704 schedules resources to the UE according to a channel state and a predetermined service state, extracts a packet of a scheduled UE from a buffer, and provides the packet to the transceiver 706. In addition to its typical function, according to the present invention, the scheduler 704 receives the UE's packet forwarded from the source eNB of the UE at the occurrence of the handover of the UE from the network manager 700 via the handover manager 702, determines a delay value of the packet by considering at least one of an X2 delay value and a queuing delay value with respect to the forwarded packet, and performs scheduling on the packet on the basis of the determined delay value.

Herein, the scheduler 704 receives the queuing delay value from the network manager 700 together with the packet of the UE via the handover manager 702, and determines a delay value of the packet by using the queuing delay value or determines the delay value of the packet by using a sum of the queuing delay value of the UE and a predetermined X2 delay value according to the embodiment of the present invention. In addition, the scheduler 704 may determine the delay value of the packet by using the predetermined X2 delay value according to another embodiment of the present invention.

In addition, the scheduler 704 measures a roundtrip time by transmitting and receiving a ping message with respect to the source eNB via the network manager 700 according to the embodiment of the present invention, and a value obtained by subtracting a message processing time of a specific size from the measured value is divided by 2 in order to determine the X2 delay value. In addition, the scheduler 704 transmits a first message additionally defined for X2 delay measurement according to another embodiment of the present invention to the source eNB via the network manager 700 by inserting a first time stamp to the first message, and receives a second message including the first time stamp and a second time stamp from the source eNB via the network manager 700, in order to determine the X2 delay time. Herein, the first time stamp is a time stamp at which the eNB transmits the first message, and the second time stamp is a time stamp at which the source eNB transmits the second message.

In addition, the scheduler 704 receives a third time stamp and a fourth time stamp together with the packet of the UE from the source eNB via the network manager 700, and may determine the queuing delay value by determining a difference between the third time stamp and the fourth time stamp. Herein, the third time stamp is a time stamp at which the packet arrives to the source eNB, and the fourth time stamp is a time stamp at which the source eNB forwards the packet.

The transceiver 706 demodulates and decodes a signal received from the UE through an antenna and provides a handover related message to the handover manager 702. Further, the transceiver 706 codes and modulates the handover related message provided from the handover manager 702 and a packet provided from the scheduler 704, and delivers the message or the packet to the UE through the antenna.

Next, the structure of the source eNB will be described with reference to FIG. 7. Herein, since operations of the handover manager 702 and the transceiver 706 of the source eNB are the same as operations of the handover manager 702 and the transceiver 706 of the target eNB, descriptions thereof will be omitted.

The network manager 700 communicates with a different eNB through an X2 interface. That is, the network manager 700 interprets a message received from the different eNB, and performs a function of generating and transmitting a transmission message. In addition to its typical function, according to the present invention, the network manager 700 receives a packet which is not yet transmitted to the UE and a queuing delay value of the packet with respect to the UE that performs a handover from the scheduler 704 via the handover manager 702, and forwards the queuing delay value to the target eNB of the UE.

The scheduler 704 schedules resources to the UE according to a channel state and a predetermined service state, extracts a packet of a scheduled UE from a buffer, and provides the packet to the transceiver 706. In addition to its typical function, according to the present invention, the scheduler 704 determines whether there is a packet which is not yet transmitted to the UE, with respect to the UE that performs the handover. If there is the packet which is not yet transmitted to the UE, the scheduler 704 provides the packet to the network manager 700 via the handover manager 702. Herein, the scheduler 704 confirms the queuing delay value of the packet, and thereafter may provide the queuing delay value to the network manager 700 via the handover manager 702 together with the packet. As the queuing delay value of the packet, the scheduler 704 provides a first time stamp and a second time stamp to the network manager 700. The first time stamp is a time stamp at which the packet arrives to the eNB. The second time stamp is a time stamp at which the eNB forwards the packet.

According to exemplary embodiments of the present invention, a source eNB forwards information on a queuing delay to a target eNB together with a downlink packet of a UE at the occurrence of a handover of the UE in a wireless communication system. In addition, the target eNB performs scheduling by considering at least one of an X2 delay and a queuing delay with respect to a downlink packet forwarded from the source eNB, thereby being able to minimize degradation of QoS caused by the handover. Therefore, the target eNB may persistently guarantee QoS of a service provided from the source eNB to the UE even at the occurrence of the handover.

While the present invention has been particularly shown and described with reference to exemplary embodiments thereof, it will be understood by those skilled in the art that various changes in form and details may be made therein without departing from the spirit and scope of the present invention as defined by the appended claims.

1. A method of scheduling a forwarding packet by a target evolved NodeB (eNB) in a wireless communication system, the method comprising:
receiving a packet of a User Equipment (UE) forwarded from a source eNB of the UE at the occurrence of a handover of the UE;
determining a delay value of the packet based on at least one of an X2 delay value and a queuing delay value with respect to the forwarded packet; and
scheduling the packet based on on of the determined delay value.

2. A target evolved NodeB (eNB) configured to schedule a forwarding packet in a wireless communication system, the target eNB comprising:
a network manager configured to receive a packet of a User Equipment (UE) forwarded from a source eNB of the UE at the occurrence of a handover of the UE; and
a scheduler configured to determine a delay value of the packet based on at least one of an X2 delay value and a queuing delay value with respect to the forwarded packet, and to schedule the packet based on the determined delay value.

3. The method of claim 1, further comprising receiving the queuing delay value forwarded from the source eNB with the packet of the UE.

4. The method of claim 3, wherein receiving the forwarded queuing delay value of the UE further comprising:
receiving first and second time stamps forwarded from the source eNB together with the packet of the UE, wherein the first time stamp is a time stamp at which the packet arrives at the source eNB and the second time stamp is a time stamp at which the source eNB forwards the packet; and
determining the queuing delay value by determining a difference between the first time stamp and the second time stamp.

5. The method of claim 1, wherein the delay value of the packet is determined based on the queuing delay value of the UE.

6. The method of claim 1, wherein the delay value of the packet is determined based on a sum of the queuing delay value of the UE and a predetermined X2 delay value.

7. The method of claim 1, wherein the delay value of the packet is determined based on a predetermined X2 delay value.

8. The method of claim 1, further comprising determining the X2 delay value.

9. The method of claim 8, wherein determining the X2 delay value comprises:
measuring a roundtrip time by transmitting and receiving a ping message with respect to the source eNB; and
dividing a value obtained by subtracting a message processing time from a measurement result value by 2.

10. The method of claim 8, wherein determining the X2 delay value comprises:
transmitting to the source eNB a first message defined additionally for X2 delay measurement by inserting a first time stamp into the first message, wherein the first time stamp is a time stamp at which the target eNB transmits the first message; and
receiving a second message including the first time stamp and a second time stamp from the source eNB, wherein the second time stamp is a time stamp at which the source eNB transmits the second message.

11. A method for forwarding a packet by a source evolved NodeB (eNB) in a wireless communication system, the method comprising:
determining whether a packet is present that has not been transmitted to a User Equipment (UE) that performed a handover;
confirming a queuing delay value of the packet in response to determining that the packet has not been transmitted to the UE; and
forwarding the confirmed queuing delay value to a target eNB of the UE with the packet.

12. A source evolved NodeB (eNB) for forwarding a packet in a wireless communication system, the source eNB comprising:
a scheduler configured to determine whether a packet is present not been transmitted to a User Equipment (UE) that performed a handover, and to confirm a queuing delay value of the packet in response to determining that the packet has not been transmitted to the UE; and
a network manager configured to forward the confirmed queuing delay value to a target eNB of the UE with the packet.

13. The method of claim 11, wherein forwarding the queuing delay value comprises forwarding a first time stamp and a second time stamp together with the packet, wherein the first time stamp is a time stamp at which the packet arrives at the source eNB and the second time stamp is a time stamp at which the source eNB forwards the packet.

14. The source eNB of claim 12, wherein to forward the queuing delay value, the network manager is further configured to forward a first time stamp and a second time stamp together with the packet, wherein the first time stamp is a time stamp at which the packet arrives at the source eNB and the second time stamp is a time stamp at which the source eNB forwards the packet.

15. The target eNB of claim 2, wherein the network manager is configured to receive the queuing delay value forwarded from the source eNB with the packet of the UE.

16. The target eNB of claim 15, wherein:
the network manager is configured to receive first and second time stamps forwarded from the source eNB with the packet of the UE, wherein the first time stamp is a time stamp at which the packet arrives at the source eNB and the second time stamp is a time stamp at which the source eNB forwards the packet; and
the scheduler is configured to determine the queuing delay value by determining a difference between the first time stamp and the second time stamp.

17. The target eNB of claim 2, wherein the delay value of the packet is determined based on the queuing delay value of the UE.

18. The target eNB of claim 2, wherein the delay value of the packet is determined based on a sum of the queuing delay value of the UE and a predetermined X2 delay value.

19. The target eNB of claim 2, wherein the delay value of the packet is determined based on a predetermined X2 delay value.

20. The target eNB of claim 2, wherein the scheduler is configured to determine the X2 delay value.

21. The target eNB of claim 20, wherein to determine the X2 delay value, the scheduler is further configured to measure a roundtrip time by transmitting and receiving a ping message with respect to the source eNB, and divide a value obtained by subtracting a message processing time from a measurement result value by 2.

22. The target eNB of claim 20, wherein to determine the X2 delay value the scheduler is further configured to transmit to the source eNB a first message defined additionally for X2 delay measurement by inserting a first time stamp into the first message, wherein the first time stamp is a time stamp at which the target eNB transmits the first message; and receive a second message including the first time stamp and a second time stamp from the source eNB, wherein the second time stamp is a time stamp at which the source eNB transmits the second message.
